(19) United States
(12) Patent Application Publication
(10) Pub. No.: US 2006/0227295 A1
(43) Pub. Date: Oct. 12, 2006

(54) Light-projector

(75) Inventors: Martin Dobler, Dusseldorf (DE); Dirk Pophusen, Bergisch-Gladbach (DE); Matthias Boll, Koln (DE); Udo Guttermann, Krefeld (DE); Friedrich Jonas, Aachen (DE); Andreas Elschner, Mulheim (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/397,241

(22) Filed: Apr. 3, 2006

(30) Foreign Application Priority Data
Apr. 6, 2005 (DE) 102005015903.6

(51) Int. Cl. G03B 21/00

(52) U.S. Cl. 353/33

(57) ABSTRACT

A light-projector that enable its own de-icing or removal of condensation water therefrom and thus suitable as, among others headlights, rear lights and other illuminating devices in motor vehicles is disclosed. The structure of the light projector includes a housing having a light-exit aperture, a lens covering the aperture, and a light source. The cover lens includes at least one transparent electrically conductive layer.

### FIELD OF THE INVENTION

The invention relates to a light-projector and in particular light projectors equipped with a heating device.

### BACKGROUND OF THE INVENTION

Light-projectors—such as, for example, front lights, rear lights and other illuminating devices for motor vehicles—do not, as a rule, require a special de-icing appliance or an appliance for the avoidance of misting, provided that use is made of conventional halogen lamps or gas-discharge lamps. These lamps produce sufficient heat to thaw ice and snow and to remove misting by condensation water. On the other hand, light-projectors with cold lighting means such as light-emitting diodes (LEDs), or even light-projectors with xenon lamps, do not generate a sufficient amount of heat and therefore display a defrosting power that is too low. Icing or misting on the cover lens of light-projectors is troublesome not only for aesthetic reasons. For safety reasons, the beam of light should not be attenuated or scattered when emerging from the light-projector.

A vehicle headlamp is known from DE 103 46 270 A, in the housing of which a heating device, preferably a PTC (positive temperature coefficient) heating element, is arranged. In DE 103 46 270 A a combination is also described of a PTC heating element with a conventional light source that has a large infrared component, such as halogen lamps for example. A principal advantage of LED headlamps, however, is the smaller construction space and the greater design freedom. A combination of halogen and LED headlamps is therefore not desirable.

JP 2003197013 A, JP 2002150812 A and JP 2002211309 A describe the incorporation of heating wires into the cover lens of vehicle headlamps. But conventional heating wires are clearly visible and are unacceptable for aesthetic reasons. What are desired are possibilities for de-icing that are not visible or that are difficult to discern.

JP 10312705 A describes the incorporation of films or sheets in vehicle headlamps by means of insert moulding. The films or sheets are provided with conductive pastes.

The object of the present invention is to provide a light-projector, in particular for vehicles, that enables de-icing or removal of condensation water in simple manner. The de-icing appliance is to be invisible or difficult to discern.

### SUMMARY OF THE INVENTION

A light-projector that enable its own de-icing or removal of condensation water therefrom and thus suitable as, among others headlights, rear lights and other illuminating devices in motor vehicles is disclosed. The structure of the light projector includes a housing having a light-exit aperture, a lens covering the aperture, and a light source. The cover lens includes at least one transparent electrically conductive layer.

### DETAILED DESCRIPTION OF THE INVENTION

The object is achieved by the cover lens of the light-projector being covered with at least one transparent electrically conductive layer.

The invention provides a light-projector for vehicles, comprising a light-projector housing with a light-exit aperture, a cover lens for covering the light-exit aperture, and a light source. The cover lens including at least one transparent electrically conductive layer.

Suitable as light-projectors are all known searchlights, spotlights, floodlights and headlamps, in particular vehicle headlamps. In a preferred embodiment, the light source is at least one light-emitting diode.

The cover lens may be of any transparent material and its surface may be structured or unstructured. The cover lens may be constructed from several layers. Suitable materials include silicate glasses and transparent thermoplastics. The thermoplastics may be lacquered or unlacquered. Commercial scratch-resistant lacquers, for example those based on siloxane, polyurethane or acrylate are among the suitable ones.

Suitable thermoplastics include polycarbonates or copolycarbonates based on diphenols, polyacrylates or copolyacrylates and polymethacrylates or copolymethacrylates, preferably polymethyl methacrylate, polymers or copolymers with styrene, preferably transparent polystyrene or polystyrene acrylonitrile (SAN), transparent thermoplastic polyurethanes, and also polyolefins, preferably transparent polypropylene types, or polyolefins based on cyclic olefins (e.g. Topas®, a product of Ticona), polycondensates or copolycondensates of terephthalic acid, preferably polyethylene terephthalate or copolyethylene terephthalate (PET or COPET) or glycol-modified PET (PETG).

Particularly preferred materials for light-projector cover lens are silicate glass, bisphenol A polycarbonate, copolycarbonates formed from bisphenol A and 1,1-bis(4-hydroxyphenyl)-3,3,5-trimethylcyclohexane, and also polymethyl methacrylates and co-methyl methacrylates.

The cover lens of the light-projector according to the invention is provided with at least one transparent conductive layer. The transparent conductive layer may have been applied either onto the outside or onto the inside of the cover lens of the light-projector. It is preferably applied on the inside of the cover lens. The transparent conductive layer may cover either the entire cover lens or only regions, for example band-shaped or strip-shaped regions, of the cover lens.

By way of materials for a transparent conductive layer, TCOs (transparent conductive oxides) enter into consideration, for example ITO (tin-doped indium oxide), ATO (antimony tin oxide), FTO (fluorine-doped tin oxide) or AZO (aluminium zinc oxide), or organic transparent conductive coatings.

Use is preferably made of organic conductive coatings. Suitable polymers for producing a transparent electrically conductive coating are polyanilines, polypyrroles or polythiophenes. Preferred are polythiophenes based on optionally substituted 3,4-ethylene dioxythiophenes. The production of these 3,4-polyethylene dioxythiophenes is described in EP 440 957 (=U.S. Pat. No. 5,300,575 incorporated herein by reference) A, for example. Particularly preferred is 3,4-polyethylene dioxythiophene/polystyrene sulfonate.

The transparent electrically conductive layer may be applied onto the light-projector cover lens by processes known as such, such as spraying, blade coating or curtain coating.

The layer thickness of the transparent electrically conductive layer is preferably 0.1 μm to 10 μm, particularly preferably 0.2 μm to 2 μm, as dry film.

The transparent electrically conductive layer by way of heating device is expediently provided with suitable sensors and with suitable control electronics, in order to operate the power input of the coating automatically and to match it to the loading state of the on-board power supply at a given moment.

### EXAMPLE

To demonstrate the heating action of a layer consisting of 3,4-polyethylene dioxythiophene/polystyrene sulfonate, a polycarbonate film with a thickness of 125 μm was coated with a dispersion containing 3,4-polyethylene dioxythiophene/polystyrene sulfonate, Baytron F HC (manufacturer: H. C. Starck GmbH), in a wet-film thickness of 24 μm and was subsequently dried for 5 minutes at 130° C.

The sample had good optical properties such as transparency, color, and was free from visible haze. The coating had a surface resistivity of 130 ohm/sq.

The coated polycarbonate film was cut to 10 cm×10 cm and was contacted to an electrical power supply on two opposite sides. The measured current/voltage response is represented in the following table. The film was palpably warm.

| Voltage (V) | Current (mA) |
|---|---|
| 5 | 39 |
| 10 | 78 |
| 15 | 117 |
| 20 | 157 |
| 25 | 197 |
| 30 | 235 |
| 35 | 274 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A light-projector comprising a light-projector housing having a light-exit aperture, a cover lens covering said aperture, and a light source, said cover lens including at least one transparent electrically conductive layer.

2. The light-projector according to claim 1 wherein the conductive layer is inside the housing.

3. The light-projector according to claim 1 wherein the conductive layer comprise an organic material.

4. The light projector of claim 3 wherein the organic material is a member selected from the group consisting of polyaniline, polypyrrole and polythiophene.

5. The light projector of claim 3 wherein the organic material is 3,4-polyethylene dioxythiophene/polystyrene sulfonate.

6. The light-projector according to claim 1 wherein the light source is a light-emitting diode.
